(19) United States
(12) Patent Application Publication
(10) Pub. No.: US 2007/0130994 A1
(43) Pub. Date: Jun. 14, 2007

(54) Method and apparatus for drawing a low liquidus viscosity glass

(76) Inventors: Olus Naili Boratav, Ithaca, NY (US); Frank Thomas Coppola, Horseheads, NY (US); Andrey V. Filippov, Painted Post, NY (US); Allan Mark Fredholm, Hericy (FR); Michael Brian Gildea, Painted Post, NY (US); Bruno Le Gallic, Fontainbleau (FR); George Clinton Shay, Moneta, VA (US)

Correspondence Address: CORNING INCORPORATED, SP-TI-3-1, CORNING, NY, 14831, US

(21) Appl. No.: 11/598,377

(22) Filed: Nov. 13, 2006

Related U.S. Application Data
(60) Provisional application No. 60/748,887, filed on Dec. 8, 2005.

(51) Int. Cl. C03B 18/22; C03B 13/00; C03B 5/24

(52) U.S. Cl. 65/29.21; 65/90; 65/324; 65/162

(57) ABSTRACT

A method of a drawing a glass ribbon from molten glass sheet via a downdraw process by creating a temperature drop across a thickness of the molten glass flowing over forming surfaces of a forming wedge. The forming wedge includes an electrically conductive material for heating the glass above the root.

This application claims the benefit of priority under 35 U.S.C. § 119(e) of U.S. Provisional Application Ser. No. 60/748887 filed on Dec. 8, 2005, the contents of which are incorporated herein in their entirety by reference.

### BACKGROUND OF THE INVENTION

1. Field of the Invention

This invention is directed to a method and apparatus for forming a glass sheet, and in particular, forming a temperature drop across a thickness of molten glass flowing over a forming wedge to enable the drawing of low viscosity glasses via a downdraw process.

2. Technical Background

Glass display panels in the form of liquid crystal displays (LCDs) are being used in an increasing variety of applications—from hand-held personal data assistants (PDAs) to computer monitors to television displays. These applications require glass sheets which have pristine, defect-free surfaces. LCDs are comprised of at least several thin sheets of glass which are sealed together to form an envelope. It is highly desirable that the glass sheets which comprise these displays do not deform when cut, thereby maintaining the proper registration, or alignment, between the elements. Residual stress which may be frozen into the glass, if relieved by cutting the glass into smaller portions, may result in deformation of the glass, and a loss of proper registration.

Typically, LCDs are of the amorphous silicon (α-Si) thin film transistor (TFT) or, more recently, polycrystalline-silicon (ρ-Si or poly-Si) TFT type. It is possible, using ρ-Si processing, to build the display drive circuitry directly on the glass substrate. By contrast, α-Si requires discrete driver chips that must be attached to the display periphery utilizing integrated circuit packaging techniques.

The evolution from α-Si to ρ-Si has presented a major challenge to the use of a glass substrate. Poly-Si coatings require much higher processing temperatures than do α-Si, in the range of 600-700°. Thus, the glass substrate must be thermally stable when heated to such temperatures. Thermal stability (i.e. thermal compaction or shrinkage) is dependent upon both the inherent viscous nature of a particular glass composition (as indicated by its strain point) and the thermal history of the glass sheet as determined by the manufacturing process. High temperature processing, such as required by poly-Si TFTs, may require long annealing times for the glass substrate to ensure low compaction.

One method of producing glass for optical displays is by an overflow downdraw process. U.S. Patent Nos. 3,338,696 and 3,682,609 (Dockerty), which are incorporated in their entirety herein by reference, disclose a fusion downdraw process which includes flowing a molten glass over the edges, or weirs, of a forming wedge, commonly referred to as an isopipe. The molten glass flows over converging forming surfaces of the isopipe, and the separate flows reunite at the apex, or root, where the two converging forming surfaces meet, to form a glass ribbon, or sheet. Thus, the glass which has been in contact with the forming surfaces is located in the inner portion of the glass sheet, and the exterior surfaces of the glass sheet are contact-free. Pulling rolls are placed downstream of the isopipe root and capture edge portions of the ribbon to adjust the rate at which the ribbon leaves the isopipe, and thus help determine the thickness of the finished sheet. The contacted edge portions are later removed from the finished glass sheet. As the glass ribbon descends from the root of the isopipe past the pulling rolls, it cools to form a solid, elastic glass ribbon, which may then be cut to form smaller sheets of glass

A current limitation of the fusion draw process is related to the material properties of the glass to be processed. It is well known that when a glass composition initially in the molten state is exposed to a sufficiently low temperature for a significant amount of time, the development of crystal phases will initiate. The temperature where these crystal phases start to develop is known as the liquidus temperature. The crystallization point may also be cast in terms of the liquidus viscosity, which is the viscosity of the particular glass composition at the liquidus temperature.

As known and currently practiced, when using the fusion draw process it is necessary to maintain the viscosity of the glass at the location where it leaves the isopipe at a value greater than about 100,000 poise, more typically greater than about 130,000 poise. If the glass has a viscosity lower than about 100,000 poise, the quality of the sheet degrades, e.g. in terms of maintaining the sheet flatness and controlling the thickness of the sheet across its width, and glass sheet thus produced is no longer suitable for display applications.

According to current practice, if a glass composition which has a liquidus viscosity of less than about 100,000 poise is processed under conditions such that the dimensional quality of the glass sheet would be adequate, devitrification may develop on the isopipe and lead to crystalline particulate in the glass sheets. This is not acceptable for display glass applications.

### SUMMARY

In an embodiment according to the present invention, a method of forming a glass sheet is disclosed comprising flowing a molten glass having a liquidus viscosity less than about 100,000 poise over a forming wedge to form a glass ribbon, the forming wedge comprising forming surfaces which converge at an apex, heating the apex by flowing a current through an electrically conductive material comprising the forming wedge, cooling a surface of the molten glass, and wherein the heating and cooling is sufficient to form a temperature drop across a thickness of the molten glass adjacent the forming surfaces greater than about 20° C.

In another embodiment according to the present invention, an apparatus for forming a glass sheet is provided comprising a forming wedge comprising forming surfaces which converge at an apex, and an electrically conductive material for heating a molten glass flowing over the forming surfaces by flowing a current through the material. Preferably, the glass is heated proximate the apex.

The invention will be understood more easily and other objects, characteristics, details and advantages thereof will become more clearly apparent in the course of the following explanatory description, which is given, without in any way implying a limitation, with reference to the attached Figures. It is intended that all such additional features and advantages be included within this description, be within the scope of the present invention, and be protected by the accompanying claims.

### BRIEF DESCRIPTION OF THE DRAWINGS

FIG. 1 is a perspective, partial cross sectional view of a fusion downdraw apparatus.

FIG. 2 is a cross sectional view of a portion of the forming wedge of FIG. 1, showing the glass flow over the converging surfaces thereof.

FIG. 3 is a cross sectional view of a portion of the forming wedge of FIG. 1 showing an electrically conductive material embedded within the forming wedge proximate the forming wedge apex and used to heat the glass flowing over the forming surfaces.

FIG. 4 is a cross sectional view of a portion of the forming wedge of FIG. 1 showing an electrically conductive material cladding disposed over the forming wedge proximate the forming wedge apex and used to heat the glass flowing over the forming surfaces.

FIG. 5 is a cross sectional view of a portion of the forming wedge of FIG. 1 showing the apex of the forming wedge formed by a cap comprised of electrically conductive material and used to heat the glass flowing over the forming surfaces.

FIG. 6 is a cross sectional view of a portion of the forming wedge of FIG. 5 showing the apex of the forming wedge formed by a cap comprised of electrically conductive material and containing a void.

FIG. 7 is a cross sectional view of a portion of the forming wedge of FIG. 1 showing an the forming wedge with a keel member formed from an electrically conductive material and used to heat the glass.

FIG. 8 is a cross sectional view of a portion of the forming wedge of FIG. 1 showing a cladding-type electrically conductive element comprising the forming wedge, and a device located opposite a forming surface for cooling the glass flowing over the forming surface.

### DETAILED DESCRIPTION

In the following detailed description, for purposes of explanation and not limitation, example embodiments disclosing specific details are set forth to provide a thorough understanding of the present invention. However, it will be apparent to one having ordinary skill in the art, having had the benefit of the present disclosure, that the present invention may be practiced in other embodiments that depart from the specific details disclosed herein. Moreover, descriptions of well-known devices, methods and materials may be omitted so as not to obscure the description of the present invention. Finally, wherever applicable, like reference numerals refer to like elements.

As used herein, a downdraw glass sheet manufacturing process refers to any form of glass sheet manufacturing processes in which glass sheets are formed while viscous glass is drawn in a downward direction. In a fusion downdraw forming process particularly, molten glass flows into a trough, then overflows and runs down both sides of a pipe or forming wedge. The two flows fuse together at what is known as the root (where the pipe ends and the two overflow portions of glass rejoin), and the combined flow is drawn downward until cool.

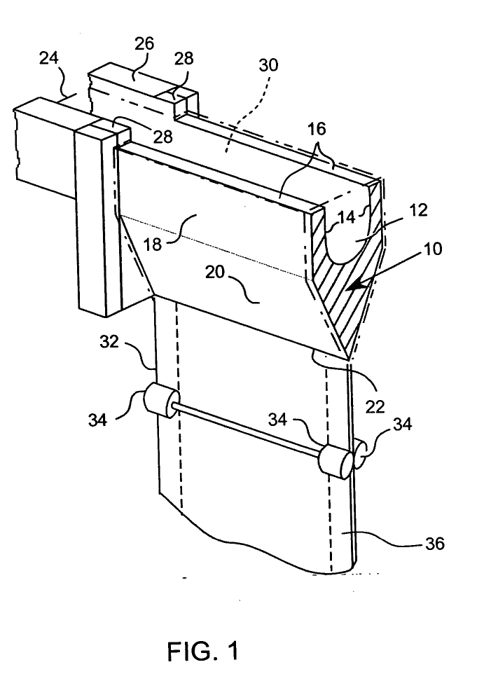

The overflow glass sheet manufacturing process can be described with the help of FIG. 1, wherein forming wedge 10 includes an upwardly open channel 12 bounded on its longitudinal sides by wall portions 14, which terminate at their upper extent in opposed longitudinally-extending overflow lips or weirs 16. The weirs 16 communicate with opposed outer sheet forming surfaces of forming wedge 10. As shown, forming wedge 10 is provided with a pair of substantially vertical forming surface portions 18 which communicate with weirs 16, and a pair of downwardly inclined and converging surface portions 20 which terminate at a substantially horizontal lower apex 22 forming a straight, glass draw line.

Molten glass 24 is fed into channel 12 by means of delivery passage 26 communicating with channel 12. The feed into channel 12 may be single ended or, if desired, double ended. A pair of restricting dams 28 are provided above overflow weirs 16 adjacent each end of channel 12 to direct the overflow of the free surface 30 of molten glass 24 over overflow weirs 16 as separate streams, and down opposed forming surface portions 18, 20 to root 22 where the separate streams, shown in chain lines, converge to form a sheet, or ribbon, of virgin-surfaced glass 32.

In the fusion process, a pulling device in the form of pulling rolls or rollers 34 are placed downstream of forming wedge root 22 and are used to adjust the rate at which the formed ribbon of glass leaves the converging forming surfaces and thus help determine the nominal thickness of the finished sheet. Suitable pulling rolls are described, for example, in published U.S. patent application Ser. No. 2003/0181302. The pulling rolls are preferably designed to contact the glass ribbon at its outer edges. The glass edge portions 36 which are contacted by the pulling rolls are later discarded from the sheet.

One advantage to the fusion forming process described above is that the ribbon can be formed without the external ribbon surfaces contacting the forming surfaces. This provides for smooth, contaminant-free ribbon surfaces. In addition, this technique is capable of forming very flat and thin glass sheets to very high tolerances. However, other glass sheet forming techniques may also benefit from the present invention, including, but not limited to, slot draw and single-sided overflow downdraw forming techniques. In the slot draw technique, molten glass flows into a trough having a machined slot in the bottom. The glass is pulled down through the slot, thereby forming a ribbon of glass. The quality of the glass is obviously dependent, among other things, on the accuracy of the machined slot.

The fusion draw process is capable of producing very high quality glass sheets. One of its limitations, however, is that high quality sheets can only be obtained if the glass viscosity on the forming surfaces 18, 20, and particularly at the point where the glass leaves the forming wedge (i.e. the apex or root), is kept at a sufficiently high viscosity. As molten glass 24 overflows the forming wedge weirs, it is a relatively high temperature-low viscosity glass, on the order of about 50,000 poise for some glasses used in the display industry. As the glass flows down forming surfaces 18, 20, it cools and the viscosity increases, until at the apex of the converging forming surfaces the viscosity of the glass is sufficiently high that a commercially viable glass sheet may be drawn for a given draw rate and glass thickness, and assuming an appropriate glass composition. It is currently believed that a viscosity at the apex not lower than about 100,000 poise is required to produce quality glass with current glass compositions and processing parameters.

In spite of the success of current downdraw forming techniques, and in particular the fusion downdraw process, commercial requirements are driving a need for high strain point glass in display applications in order to provide for minimal post-forming dimensional changes in the glass (compaction), such as may occur during subsequent processing by customers. For the family of glass compositions currently in use or under consideration for display applications, a high strain point typically incurs also a high liquidus temperature (i.e. a low liquidus viscosity). To ensure that crystallization does not occur, the temperature of the glass should be maintained above the liquidus temperature. If the residence time of glass below the liquidus temperature is too long, the glass may begin to crystallize. However, operation of the draw process at temperatures higher than the liquidus temperature may result in a viscosity at the forming wedge apex which may make drawing of the glass difficult by creating, for example, warp in the drawn glass. Thus, on one hand a high forming temperature may be needed to avoid operation below the liquidus temperature, while on the other hand the high temperature may preclude successful forming of the glass into a sheet using a fusion downdraw glass manufacturing method. These competing requirements have heretofore limited the range of suitable glass compositions which may be used in a fusion downdraw process.

Unfortunately, the latitude to significantly change downstream processing steps to accommodate a low liquidus viscosity glass (high liquidus temperature) is limited. For example, increasing the flow rate to accommodate a lower viscosity glass at the root requires an accompanying increase in the draw rate, which then requires a corresponding increase in glass handling capability downstream. Such changes can lead to considerable capital expenses, and depending upon space restrictions, may not even be possible at a given facility. The ability to draw glass compositions with liquidus viscosities below about 100,000 poise without significant changes to downstream processing methods would therefore have great value by opening the fusion method to a range of new and potentially useful glass compositions. For example, glass compositions having a strain point higher than about 665° C. may be useful for certain display glass applications, such as in the ρ-Si deposition process where reduced compaction is needed. If, for instance, a glass having a strain point of at least about 665° C. strain point (e.g. 750° C.) is required, no fuision-formable glass composition has been identified to date which may be fusion drawn into an acceptable drawn glass sheet without modifying downstream processes.

In an embodiment of the present invention, the molten glass flowing over the forming surfaces may be locally cooled above the apex of the forming wedge while simultaneously heating the forming surfaces beneath the flowing glass to achieve the required glass viscosity at the forming wedge apex.

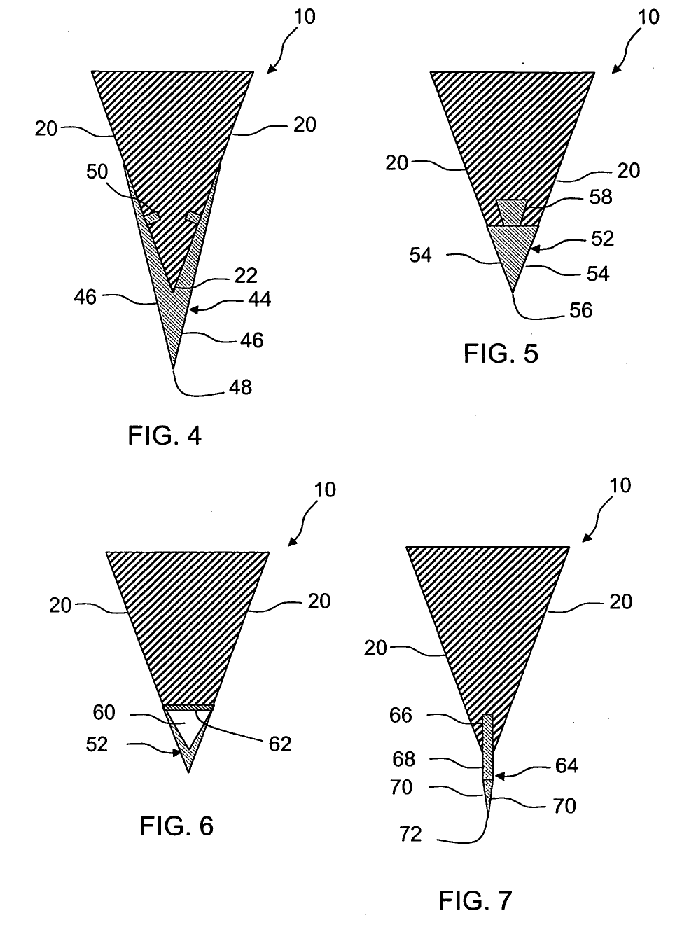

It has been found that in a conventional fusion downdraw process the glass flowing over the forming surfaces is relatively homogeneous in temperature, varying by less than about 10°C. from the wedge-glass interface, through thickness T of the glass, to the glass-air interface. This temperature variation may, in some cases, be less than about 5° C. That is, the layer 38 adjacent the forming surfaces in FIG. 2 loses heat at a rate approximately equal to the heat loss of layer 40, such that a temperature t₁ of glass layer 100 is approximately the same as the temperature t₂ of glass layer 40. (For simplicity, the flow of molten glass 24 in FIG. 5 is depicted as two layers at two different temperatures, t₁, and t₂. In actuality, the flow of glass over the forming surfaces and the temperature field Δt, are continuums in that they vary continuously as one progresses from the forming wedge to the outside surface of the glass. Nevertheless, it is useful to describe the flow in terms of discrete layers.) Moreover, while the residence time for the portion of glass layer 38 in direct contact with the forming surfaces has been determined to be on the order of days, the residence time for glass layer 40 opposite the forming surfaces (i.e. at the glass-air interface) is typically less than an hour. The long residence time at the wedge-glass interface can be responsible for devitrification of the glass if the temperature of the glass falls below the liquidus temperature. This becomes especially troublesome in the case of high liquidus temperature glasses as previously described: the long residence time at the surface of the forming wedge, coupled with a glass temperature which cools below the liquidus temperature as the glass descends the forming surfaces, may result in nucleation and crystal growth in the glass. The use of a high liquidus temperature glass can, however, be facilitated by heating the forming wedge, particularly along the lower portions of the forming surfaces near the apex. In this way, the temperature of the long residence time glass in contact with the forming wedge proximate the root can be maintained at a temperature above the liquidus temperature of the glass, while the average viscosity of the glass at the root or apex is maintained approximately equal to or greater than the currently acceptable lower viscosity limit for fusion drawing due to the cooler outer layers of the glass flow, e.g. greater than about 100,000 poise. It should be noted that FIG. 2 depicts only a portion of the forming wedge, and, in a fusion downdraw process, it is desirable that the forming wedge conditions be substantially symmetrical.

Heating of the forming wedge may be accomplished by providing a heating element or elements in or on the forming wedge in the vicinity of where the two flows of glass join. Heating of the forming wedge works to maintain the high residence-time glass above the liquidus temperature of the glass and preventing crystallization. External cooling of the glass near the glass-air interface, in the same region of the forming wedge where wedge heating occurs helps ensure that the average glass viscosity at the apex is sufficiently high to allow proper drawing of glass consistent with a predetermined draw rate and glass thickness. Thus, a large temperature variation Δt (=t₁−t₂) is developed through the thickness of molten glass flowing over the forming surfaces. Preferably, Δt is greater than at least about 20° C., preferably greater than about 30° C., preferably at least about 40° C., and preferably at least about 50° C.

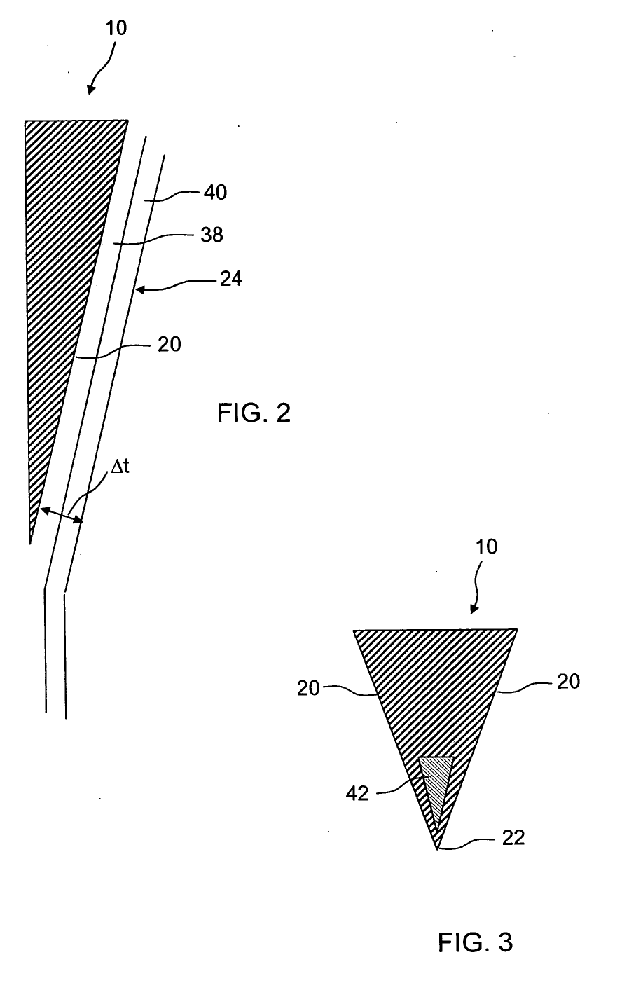

In one embodiment according to the present invention, an electrically conductive member may be incorporated into forming wedge 10 proximate apex 22 and an electrical current flowed through the member. The current flow through member 42 generates heat which heats the forming wedge, thereby heating the glass flow in contact with the forming wedge. As illustrated by FIG. 3, substantially all of electrically conductive member 42 is embedded within forming wedge 10 and, advantageously, therefore, not in contact with the glass. By substantially all what is meant is that there would obviously need to be electrical contact between the electrically conductive member and the electrical power supply. Connection between the member and the power supply, such as with electrical cables, is more easily accomplished outside of the forming wedge. However, what small portion of the electrically conductive member (e.g. heating element) residing outside the forming wedge makes only a negligible contribution to heating of the glass, if any. Because conductive member 42 does not contact the glass, the electrically conductive member may be formed from an electrically conductive material which need not necessarily be compatible with the glass chemistry. Consequently, member 42 may be comprised of, for example, coils, bars, wires or other suitable shape having an electrical connection with a power source (not shown) and capable of heating the forming wedge apex area to the necessary temperature. Preferably, member 42 comprises fine wires, as these have the least amount of impact on the physical integrity of the forming wedge.

In another embodiment, forming wedge 10 includes an electrically conductive member in the form of a cladding comprising a suitable electrically conductive refractory material, preferably a refractory metal. A suitable refractory material is one which is compatible with the glass chemistry, and therefore not prone to decomposition or leaching when exposed to the glass, and resistant to the high temperatures experienced by the forming wedge. Suitable refractory materials are preferably members of the platinum group metals, such as platinum, rhodium, a platinum-rhodium alloy, or the like. FIG. 4 illustrates a portion of forming wedge 10 having an electrically conductive cladding member 44 which covers apex 22, and the portion of converging forming surfaces 20 adjacent apex 22. Cladding 44 itself comprises converging forming surfaces 46 which converge at apex 48. Glass which flows over weirs 16 and down forming surfaces 18, 20, intercept and flow over cladding surfaces 46, then converge and join at apex 48 to form glass ribbon 32. FIG. 4 depicts one method of securing cladding 44 through the use of a lip or tab 50 formed on an inside surface of the cladding which mates with a corresponding groove formed in each converging forming surface 20. Of course, other methods of securing cladding 44 to forming wedge 10 as are known in the art may be used. For example, if the cladding material is sufficiently stiff, the cladding may be supported only at the ends of the forming wedge. However, it is desirable that the surface of cladding 44 be free of gaps, protrusions or other surface features which may disrupt the flow of glass over the surface of the cladding. Cladding 44 may then be heated by flowing a current through the cladding.

In another embodiment according to the present invention, as shown in FIG. 5, apex 22 may be replaced altogether with an electrically conductive member comprising, as above, a platinum group metal such as platinum, rhodium, platinum-rhodium alloy, or the like. As shown in FIG. 5, apex 22 of forming wedge 10 has been replaced with electrically conductive cap 52. Cap 52 comprises converging forming surfaces 54 which intersect at apex 56, and which, when cap 52 has been fitted to forming wedge 10, extend from forming surfaces 20. Advantageously, cap 52 may be fitted to forming wedge 10 such that the intersection of converging forming surfaces 20 and cap 52 present a continuous planar surface (as to surfaces 20 and 54) to the flowing glass, thereby minimizing or eliminating flow discontinuities in the transition from converging forming surfaces 20 to cap 52. As in the previous embodiment, cap 52 may be secured to forming wedge 10 by a variety of methods which do not form a disruptive surface on the cap. As shown in FIG. 5, cap 52 is secured to forming wedge 10 through a dovetail joint 58. However, cap 52 may be sufficiently rigid that the cap need only be supported at the ends thereof. As before, cap 52 is heated by flowing a current through the cap sufficient to heat the cap to a desired temperature. The amount of current, and desired temperature, are a function of the glass temperature-viscosity relationship, among other factors, and are easily determined by one having ordinary skill in the art. Cap 52 may be a solid feature, or cap 52 may be hollow (i.e. contain a void), as shown in FIG. 6. Void 60 within cap 52, as illustrated in FIG. 6 may contain an insulating material. Void 60 may be covered by cover 62, which may also be electrically conductive.

In still another embodiment of the apparatus according to the present invention wherein a lower portion of forming wedge 10 is shown wherein apex 22 has been replaced with an electrically conductive keel member 64. As before, keel member 64 is preferably comprised of a platinum group metal, or alloy thereof. At least a portion 66 of keel member 64 is embedded in forming wedge 10 at the line where converging forming surfaces 20 converge (i.e. apex 22), and another portion 68 extends outward (downward) from forming wedge 10. Keel member 64 further comprises converging forming surfaces 70 which converge at apex 72. Converging forming surfaces 70 may intersect with forming surfaces 20, or, as shown in FIG. 7, converging forming surfaces 70 may be non-intersecting with forming surfaces 20.

As described previously, various embodiments of electrically conductive heating members, either cladding, embedded heaters, caps, keels or other heating members comprising forming wedge 10 may be used to develop a temperature drop through a thickness of the glass, preferably at or near the apex of the forming wedge. In some embodiments it may be necessary to also cool the surface of the glass to produce the desired temperature drop.

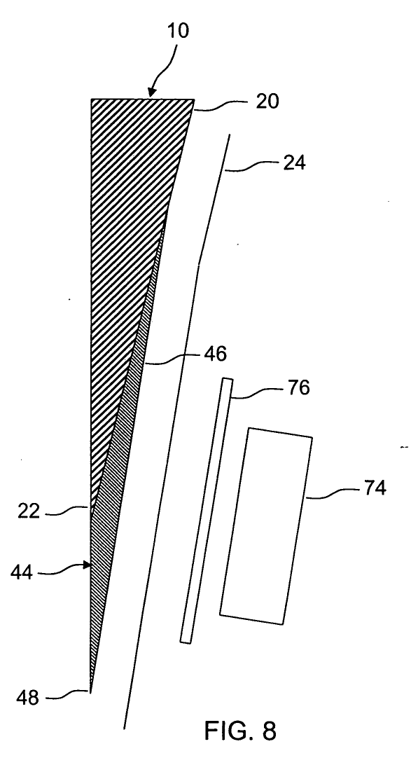

For example, FIG. 8 illustrates a portion of forming wedge 10 comprising clad-style heating member 44. Shown opposite the cladding is cooling element 74 for cooling the surface of molten glass 24. Cooling element 74 may be any cooling device suitable for creating a temperature variation greater than about 20° C. through the glass thickness opposite the cooling element when used in conjunction with any of the heating elements described herein. For example, cooling element or device 74 may be comprised of tubing extending along the length of the forming wedge through which a cooling fluid is flowed. Diffusion member 76 may be disposed between the cooling element and the surface of the glass to provide for more even heat extraction from the surface of the glass along the length of forming wedge 10. The diffusion member may be a simple metal plate, or an enclosure, disposed between the surface of the glass and the cooling element. The cooling device described above and depicted in FIG. 8 may be used in conjunction with any of the embodiments disclosed herein.

It should be emphasized that the above-described embodiments of the present invention, particularly any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A method of forming a glass sheet comprising:
flowing a molten glass having a liquidus viscosity less than about 100,000 poise over a forming wedge, the forming wedge comprising an electrically conductive member and forming surfaces which converge at an apex;
heating the forming wedge proximate the apex by flowing a current through the electrically conductive member; and
wherein the heating is effective to produce a temperature drop through a thickness of the molten glass greater than about 20° C.

2. The method according to claim 1 wherein the temperature drop is greater than about 40° C.

3. The method according to claim 1 further comprising cooling a surface of the molten glass.

4. The method according to claim 1 wherein a strain point of the molten glass is at least about 665° C.

5. The method according to claim 1 wherein the liquidus viscosity is less than about 80,000 poise.

6. The method according to claim 1 wherein an average viscosity of the glass at the apex is greater than about 100,000 poise.

7. A method of forming a glass sheet comprising
flowing a molten glass having a liquidus viscosity less than about 100,000 poise over a forming wedge to form a glass ribbon, the forming wedge comprising an electrically conductive member and forming surfaces which converge at an apex,;
heating the forming wedge proximate the apex by flowing a current through the electrically conductive member;
cooling a surface of the molten glass; and
wherein the heating and cooling is effective to produce a temperature drop through a thickness of the molten glass greater than about 20° C.

8. The method according to claim 7 wherein an average viscosity of the glass at the apex is greater than about 100,000 poise.

9. The method according to claim 7 wherein a strain point of the molten glass is at least about 665° C.

10. The method according to claim 7 wherein the temperature drop is greater than about 40° C.

11. An apparatus for forming a glass sheet comprising:
a forming wedge having an electrically conductive member for heating a molten glass flowing over the forming wedge by flowing a current through the electrically conductive member.

12. The apparatus according to claim 11 wherein the electrically conductive member comprises a cladding over at least a portion of the forming wedge.

13. The apparatus according to claim 1 I wherein the electrically conductive member comprises a cap member in abutment with the forming wedge.

14. The apparatus according to claim 11 wherein the cap member contains a void.

15. The apparatus according to claim 11 wherein the electrically conductive member comprises a keel member extending from the forming wedge.

16. The apparatus according to claim 11 wherein at least a portion of the electrically conductive member is embedded within the forming wedge.

17. The apparatus according to claim 1 1 wherein substantially all of the electrically conductive member is embedded within the forming wedge.

18. The apparatus according to claim 11 wherein the glass contacts the electrically conductive member.

19. The apparatus according to claim 11 further comprising a cooling element for cooling a surface of the molten glass.

20. The apparatus according to claim 18 wherein the cooling element is disposed opposite the electrically conductive element such that the molten glass flows between the electrically conductive member and the cooling element.
